(19) United States
(12) Patent Application Publication
(10) Pub. No.: US 2022/0041470 A1
(43) Pub. Date: Feb. 10, 2022

(54) SOLAR POWERED SANITIZING WATER BOTTLE

(71) Applicant: Sabrina Hu, Tallahassee, FL (US)

(72) Inventor: Sabrina Hu, Tallahassee, FL (US)

(21) Appl. No.: 16/986,477

(22) Filed: Aug. 6, 2020

(51) Int. Cl. C02F 1/32; C02F 1/00; B01D 29/085; H02J 7/00; H02J 7/35

(52) U.S. Cl. CPC C02F 1/325; C02F 1/002; B01D 29/085; H02J 7/0045; C02F 2307/02; C02F 2201/3222; C02F 2201/009; C02F 2201/3221; C02F 2303/04; H02J 7/35

(57) ABSTRACT

A liquid purification system is disclosed, comprising a reservoir to store a liquid and a purifier including a plurality of LED's configured to emit ultraviolet light into the reservoir and the liquid therein. A solar cell is positioned on a top of the purifier to provide power to the plurality of LED's. The solar cell may also provide power to an electronic device via a cable extending from the purifier.

### TECHNICAL FIELD

The embodiments generally relate to liquid purifying systems and, more particularly, relate to portable liquid purifying and sanitizing systems incorporated into a portable water container.

### BACKGROUND

Water purification is the process of removing undesired chemicals, biological contaminants, suspended solids, and gases from water, with the goal of producing water suitable for a specific purpose (such as consumption by a human or for medical, industrial, and chemical applications). Water purification methods include processes such as filtration, sedimentation, and distillation, and the use of slow sand filters, activated carbon filters, flocculation, chlorination, ultraviolet (UV) light, and electromagnetic radiation.

UV disinfection has been shown to be effective in sanitizing water. In fact, solar disinfection is used in many developing countries for sanitizing daily drinking water. The UV light acts by inducing the formation of covalent linkages on DNA and thereby preventing microbes from reproducing.

Portable water purification devices are known in the current arts. These devices are self-contained and easily transportable to purify water from untreated sources or to ensure water of unknown origin is sanitized. These devices are often used by inhabitants of developing countries, hikers, backpackers, campers, survivalists, military personnel, and workers operating in the wilderness or other undeveloped areas. Common techniques implemented by these portable systems utilize heat, filtration, activated carbon, chemical disinfection, UV purification, and combinations of the same.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein provide a liquid purification system, comprising a reservoir to store a liquid and a purifier, including a plurality of LED's configured to emit ultraviolet light into the reservoir and the liquid therein. A solar cell is positioned on a top of the purifier to provide power to the plurality of LED's via a Lithium Polymer (LiPo) battery. The solar cell may also provide power to an electronic device via a cable extending from the purifier. The system operates using ultraviolet light which inhibits reproduction of microbes, resulting in the liquid being safe for human consumption.

The system may be used in developing nations, during natural disasters, for camping and survival situations, or during other scenarios in which the purification of water is required. The system may be used off-grid by implementing a solar cell to provide power to the LED's while operating as a charger for electronic devices such as smartphones, tablets, smartwatches, external power supplies, and the like.

In one aspect, the purifier comprises a housing to contain a plurality of electrical components therein.

In one aspect, plurality of electrical components includes a PCB.

In one aspect, the housing is comprised of a sidewall extending between the top and a bottom.

In one aspect, the system includes a tapered portion extending between the sidewall and the bottom.

In one aspect, the tapered portion or the sidewall comprises at least one button. The button provides a means for selecting operational functions of the LED's.

In one aspect, the operations functions include at least one of the following: an ON function, and a timer function.

In one aspect, a cable is in electrical communication with a battery which is in electrical communication with the solar cell.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the solar powered water purification system, according to some embodiments;

FIG. 2 illustrates a perspective view of the purifier and reservoir, according to some embodiments;

FIG. 3 illustrates a side elevation view of the solar powered water purification system, according to some embodiments;

FIG. 4 illustrates a top plan view of the purifier, according to some embodiments;

FIG. 5 illustrates a perspective view of the solar powered water purification system in electrical communication with a computing device, according to some embodiments;

FIG. 6 illustrates a side elevation view of the solar powered water purification system, according to some embodiments; and

FIG. 7 illustrates a perspective view of the filter and reservoir, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

In general, the embodiments provided herein relate to a water purification and sanitation system (herein after “system” or “the system”) which utilizes UV-C light to purify water within a reservoir. The system includes a purifier which releasably engages with the reservoir to provide the UV-C light via an LED light system. The system includes a power source to operate the UV-C light system as well as operate a charging port allowing users to charge an electronic device such as a cellphone, tablet, laptop, external battery, or other electronic devices.

As used herein, the term “reservoir” may relate to any container used for the storage and transportation of liquid including bottles made of plastics, metals, and other materials known in the arts. It is a goal of the system to be capable of interfacing with various containers such as cans and the like. In such, the system may be readily deployable on various containers and does not need to be used with any single container type. For example, the same system may be used on an aluminum can while later being used with a plastic bottle.

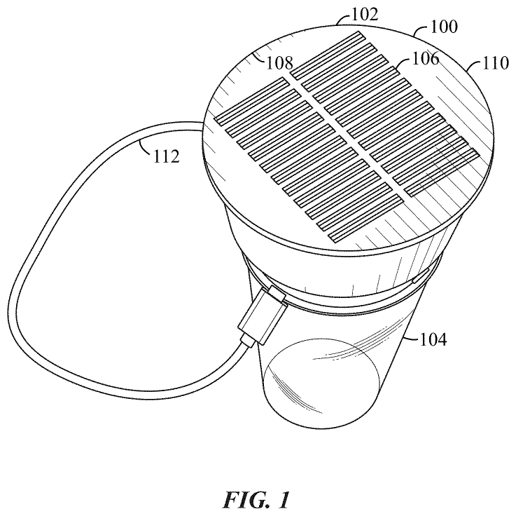

FIG. 1 illustrates a perspective view of the solar powered water purification system 100 comprising a purifier 102 releasably engaged with a reservoir 104. The purifier 102 is powered by one or more solar cells 106 on the top 108 of the purifier 102 housing 110. Solar cell 106 is in electrical communication with a battery (such as a Lithium Polymer battery) which will power one or more UV-C LED lights configured to emit light in the ultraviolet spectrum to purify/sanitize liquid within the reservoir 104 such that the liquid is safe for human consumption. A cable 112 is in electrical communication with the battery to receive power therefrom and distribute power to the purifier 102 and/or to an auxiliary electronic device such that the system 100 may function as a charger for electronic devices. The housing 110 is dimensioned to contain the electrical components of the purifier 102 and provide protection for moisture, dust, and from shock or impact.

The purifier 102 may form a substantially watertight seal with the reservoir such that the system 100 may optionally be used as a lid for the reservoir.

The LED's may be configured to emit light in an spectrum to provide sufficient purification/sanitation to the water in the reservoir 104. One skilled in the arts will readily understand that specific spectrums of UV-C light may be best suited for specific liquid compositions and volumes as well as reservoir sizes, materials, shapes, etc.

In some embodiments, the LED's may be provided on a probe which extends downward into the opening of the reservoir 104 and may be partially submerged into the liquid therein.

In some embodiments, LED's may be positioned on the bottom surface of the purifier 102 to emit light downward into the reservoir 104 and liquid therein.

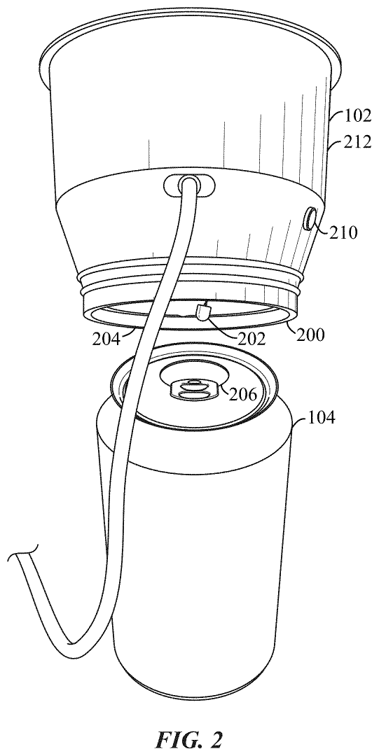

FIG. 2 illustrates a perspective view of the purifier 102 disconnected from the reservoir 104. The reservoir 104 illustrated in FIG. 2 is a can, such as an aluminum can that is commonly known and utilized in the beverage arts. The purifier 102 includes a receiving portion 200, which releasably engages with the reservoir 104 using various mechanisms including a threaded connection, clamp(s), friction fit mechanism, or the like. LED's 202 are positioned at the bottom 204 of the purifier 102 such that the LED's 202 may be at least partially inserted into the opening 206 of the reservoir 104. In some embodiments, the LED's 202 may include an extension permitting the LED's 202 to be disposed through the opening 206 and into the liquid of the reservoir 104. A button 210 is provided on a sidewall 212 and allows the user to select various functionalities of the system 100 including ON/OFF, LED spectrum settings, LED intensity settings, timer settings, etc.

In some embodiments, a plurality of buttons 210 may be provided in an array to provide the user with various functional settings options. For example, the user may utilize one or more buttons 210 to set a time for the purifier to operate the LED's 202. The system 100 may utilize a purification/sanitation protocol, such as emitting UV-C light at a predetermined intensity and light spectrum for a period of time known to purify a volume of water. One skilled in the arts will readily understand that various sizes and configurations of reservoirs 104 may be used. In some embodiments, the cable may be disconnected from the purifier, as shown in FIG. 2. In such, the cable may provide various functions including powering electronic devices, transmitting information, etc.

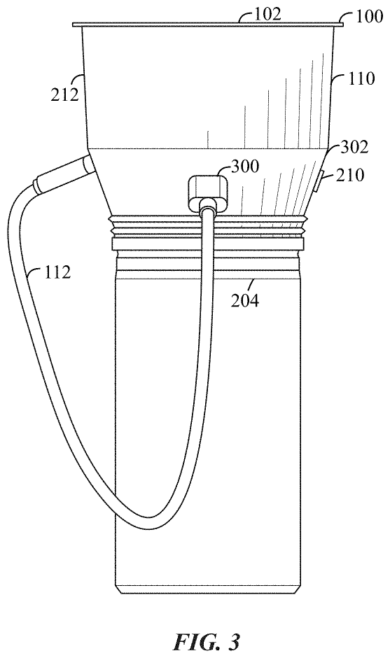

FIG. 3 illustrates a side elevation view of the solar powered water purification system 100. The cable 112 may be connected to a USB port 300 which allows the cable 112 to be connected or disconnected from the purifier 102. The cable 112 may be used as a universal charging cable for a plurality of electronic devices. The housing 110 includes a sidewall 212 and a tapered portion 302 extending from the sidewall 212 to the bottom 204. In some embodiments, the button 210 may be provided on any surface of the housing 110, including the tapered portion 302.

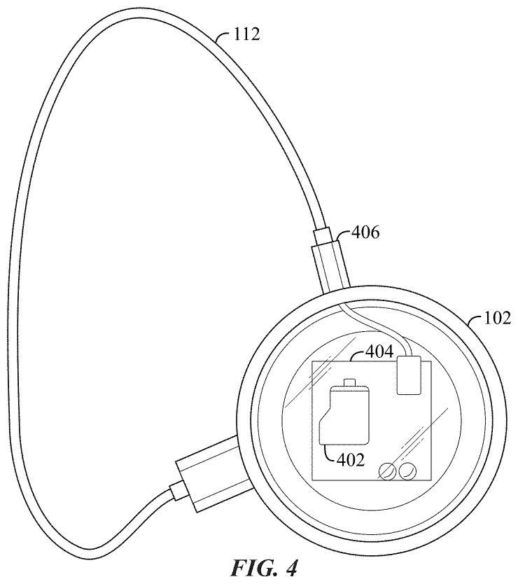

FIG. 4 illustrates a top plan view of the purifier 102 and electrical components 400, including a microprocessor 402 and PCB 404, to operate the various functionalities of the system 100. Input 406 is in electrical communication with the cable 112 to provide power from the battery. One skilled in the arts will readily understand that the PCB 404 and electrical components 400 may be provided in various configurations depending on the operational settings, configuration, and application of the system 100. In some embodiments, the cable connects to a step-up power booster which draws power from the battery.

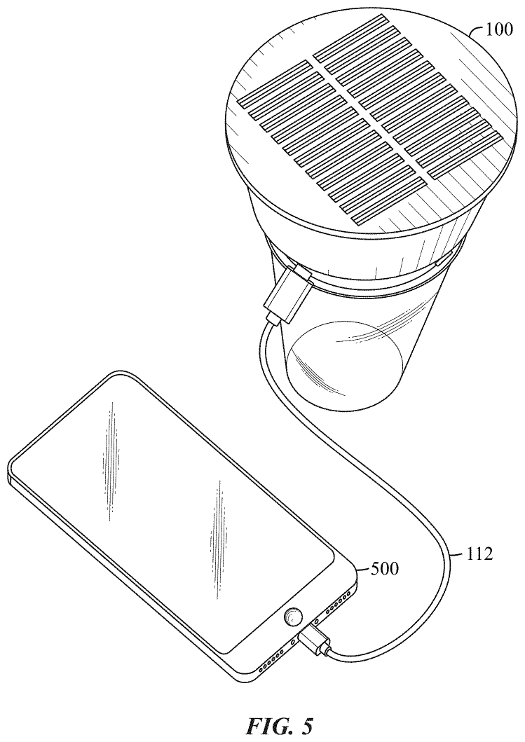

FIG. 5 illustrates a perspective view of the solar powered water purification system 100 in electrical communication with an electronic device 500. The system 100 may be used to charge the electronic device 500, which may include cellphones, tablets, laptop computers, portable gaming devices, external chargers, and the like. The electronic device 500 may also transmit information to the system 100 via a wireless or wired communication via the cable 112. In such, the electronic device 500 may provide operational instructions to the system 100 including ON/OFF functions, timer settings, LED spectrum, and LED intensity.

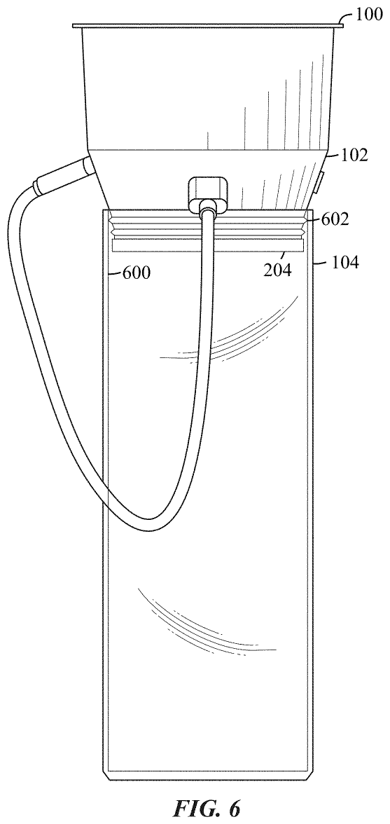

FIG. 6 illustrates a side elevation view of the solar powered water purification system 100 wherein the purifier 102 extends into the interior 600 of the reservoir 104. The purifier 102 may include an adapter 602 provided on the bottom 204 such that the adapter 602 may confirm and provide a watertight seal to a variety of reservoir 104 shapes, sizes, and types (e.g., water bottles, reusable containers, metal cans, and the like. The adapter 602 provides a means for fitting to the various shapes and sizes of liquid reservoirs 104 to allow the system 100 to deployed when needed.

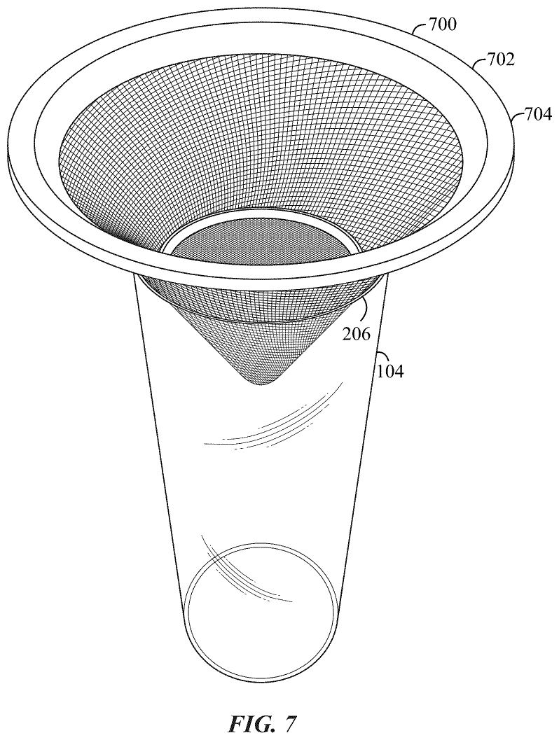

FIG. 7 illustrates a perspective view of the filter 700, which releasably engages with the opening 206 of the reservoir 104 to provide a means for filtering particles while dispensing liquid into the reservoir 104. The filter 700 may be dimensioned having a perimeter 702 larger than the opening 206 of the reservoir 104 to allow the filter 700 to be placed on top of the reservoir before the liquid is dispensed therein. An outer rim 704 provides a circumferential ring around the conical filter 700 to provide rigidity to the filter 700. The filter 700 will retain water while it dispenses through the filter and into the reservoir 104. In some embodiments, the filter 700 contains activated carbon between the cone filter and the circular filter.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A liquid purification system, comprising:
a reservoir to store a liquid;
a purifier comprising a plurality of LED's configured to emit ultraviolet light into the reservoir and the liquid therein; and
a solar cell positioned on a top of the purifier to provide power to a battery, the battery providing power to the plurality of LED's.

2. The liquid purification system of claim 1, wherein the purifier comprises a housing to contain a plurality of electrical components therein.

3. The liquid purification system of claim 2, wherein the plurality of electrical components includes a PCB.

4. The liquid purification system of claim 3, wherein the housing is comprised of a sidewall extending between the top and a bottom.

5. The liquid purification system of claim 4, further comprising a tapered portion extending between the sidewall and the bottom.

6. The liquid purification system of claim 5, wherein the tapered portion or the sidewall comprises at least one button.

7. The liquid purification system of claim 6, wherein the button provides a means for selecting operational functions of the LED's.

8. The liquid purification system of claim 7, wherein the operations functions include at least one of the following: an ON function, and a timer function.

9. The liquid purification system of claim 1, further comprising a cable in electrical communication with the battery, wherein the cable operates as a charger for an electronic device.

10. A liquid purification system, comprising:
a reservoir to store a liquid;
a purifier comprising a plurality of LED's configured to emit ultraviolet light into the reservoir and the liquid therein;
a filter releasably engaged with the reservoir to filter particles from the liquid, wherein the filter is separate from the purifier; and
a solar cell positioned on a top of the purifier to provide power to a battery, the battery providing power to the plurality of LED's.

11. The liquid purification system of claim 10, wherein the purifier comprises a housing to contain a plurality of electrical components therein.

12. The liquid purification system of claim 11, wherein the plurality of electrical components includes a PCB.

13. The liquid purification system of claim 12, wherein the housing is comprised of a sidewall extending between the top and a bottom.

14. The liquid purification system of claim 13, further comprising a tapered portion extending between the sidewall and the bottom.

15. The liquid purification system of claim 14, wherein the tapered portion or the sidewall comprises at least one button.

16. The liquid purification system of claim 15, wherein the button provides a means for selecting operational functions of the LED's.

17. The liquid purification system of claim 16, wherein the operations functions include at least one of the following: an ON function, and a timer function.

18. The liquid purification system of claim 17, further comprising a cable in electrical communication with a battery, wherein the cable operates as a charger for an electronic device.

19. The liquid purification system of claim 18, wherein the filter comprises an outer rim to provide rigidity to the filter, and wherein the perimeter of the filter is larger than an opening of the reservoir.

20. A liquid purification system, comprising:
a reservoir to store a liquid;
a purifier comprising a plurality of LED's configured to emit ultraviolet light into the reservoir and the liquid therein, the plurality of LED's extending at least partially into an interior of the reservoir;
a filter releasably engaged with the reservoir to filter particles from the liquid, wherein the filter is separate from the purifier; and
a solar cell positioned on a top of the purifier to provide power to the plurality of LED's, wherein the solar cell is in electrical communication with a cable to provide power to an electronic device.
